(19) United States
(12) Patent Application Publication
(10) Pub. No.: US 2008/0055191 A1
(43) Pub. Date: Mar. 6, 2008

(54) Methods and Systems For Displaying One or More Images on Multiple Remote Displays

(75) Inventors: Tim Craig, Georgetown, KY (US); Michael Craig, Frankfort, KY (US); Mark Craig, Georgetown, KY (US); Daniel Maggart, Georgetown, KY (US); Doug Anderson, Frankfort, KY (US)

Correspondence Address: DINSMORE & SHOHL, LLP, 1900 CHEMED CENTER, 255 EAST FIFTH STREET, CINCINNATI, OH, 45202, US

(73) Assignee: COREVALUS SYSTEMS, LLC, Georgetown, KY (US)

(21) Appl. No.: 11/848,846

(22) Filed: Aug. 31, 2007

Related U.S. Application Data
(60) Provisional application No. 60/824,154, filed on Aug. 31, 2006.
(60) Provisional application No. 60/824,172, filed on Aug. 31, 2006.
(60) Provisional application No. 60/824,180, filed on Aug. 31, 2006.
(60) Provisional application No. 60/824,193, filed on Aug. 31, 2006.
(60) Provisional application No. 60/824,190, filed on Aug. 31, 2006.

(51) Int. Cl. G09G 5/00

(52) U.S. Cl. 345/2.2; 345/2.1

(57) ABSTRACT

A system and method for displaying one or more images on multiple remote displays. An image is selected to be displayed on one or more remote displays and a remote image file is generated for the selected image. The remote image file is transmitted to one or more remote displays and the one or more remote displays are configured to display an image corresponding to the remote image file.

### CROSS REFERENCE TO RELATED APPLICATIONS

This application claims priority from U.S. Provisional Patent Application Ser. No. 60/824,154 filed Aug. 31, 2006; U.S. Provisional Patent Application Ser. No. 60/824,172 filed Aug. 31, 2006; U.S. Provisional Patent Application Ser. No. 60/824,180 filed Aug. 31, 2006; U.S. Provisional Patent Application Ser. No. 60/824,193 filed Aug. 31, 2006; and U.S. Provisional Patent Application Ser. No. 60/824,190 filed Aug. 31, 2006. The entire disclosure of which are hereby incorporated by reference herein.

### TECHNICAL FIELD

The present application relates generally to methods and systems for displaying multiple images to one or more remote displays, and more particularly, in some embodiments, to methods and systems utilizing a music sheet image file to be displayed on remote displays utilized by music group members.

### BACKGROUND

With multi-display support, a user of a computer system can utilize more than one display at a time from a single system. Multi-display is also referred to as multi-screen and multi-monitor, among other things. Conventionally, multi-displays are added if the computer's video display card has more than one monitor connector and related circuitry and software. In such instances, adding a display usually entails plugging a new monitor into the extra connection and making sure the extra monitor has been enabled on the operating system. Several manufacturers offer graphics or video display cards that include hardware, firmware and software that support two or more monitors at a time. Laptops have typically included a connector for an external monitor, as well as video support for internal display. This allows the user to have two displays at a time by using the built-in display of the laptop along with an external monitor connected to the laptop. Both displays can display the same or different images. If a desktop system does not already have an extra monitor connector, but does have available expansion slots, a user can add multi-display support by inserting one or more suitable graphics display cards. For more reliability and performance, it is generally preferable that the same graphics display card is controlling all the displays in a system. In addition, there are known to those skilled in the art, external box devices that connect to a monitor connector of a computer and divide the signal for two or more separate monitor outputs.

However, adding external devices or additional video display cards increases the price of the system and in most cases the number of video display cards added is limited by the number of open slots in the computer to hold the additional video display cards. As such, there is a need for new methods and systems for displaying multiple images on remote multiple displays. Accordingly, improved methods and systems for displaying images on the remote displays are desired.

Moreover, while some systems have been disclosed which permit sheet music to be displayed to members of a choir, band, orchestra, or other music group, such systems require expensive hardware or software at each display in order to allow the display of the music images, and/or do not enable capability to efficiently and accurately coordinate and transmit a music sheet image to multiple remote displays.

### SUMMARY

Some embodiments of the present invention relate to new and improved methods and systems for displaying images on multiple remote displays without requiring multiple video display graphics cards to be used on the server computer. In one embodiment, a method for displaying one or more static images on one or more remote displays is provided. The method comprises providing one or more remote displays, wherein the remote displays comprise the ability to display static image files, and wherein each of the remote displays has an address; generating one or more static files to be displayed on the one or more remote displays wherein the static image files correspond to the desired display output presented to a user; determining which of the remote displays to transmit the one or more static image files; determining the address of each of the remote displays; and transmitting the one or more static image files to the corresponding addresses for the one or more address displays.

In another embodiment, a method for displaying one or more images on multiple remote displays is provided. The method comprises selecting an image to be displayed on one or more remote displays, generating a remote image file corresponding to the selected image; and transmitting the remote image file to the one or more remote displays, wherein the one or more remote displays are configured such as to display an image corresponding to the remote image file.

Yet another embodiment is a system for displaying one or more static images on multiple remote displays. The system comprises a controller and communication with one or more remote displays and primary display; a screen shot generator, wherein the screen shot generator is adapted to create an image file wherein the image file comprises an image corresponding to the desired screen display; and a communication link wherein the communication link is utilized to transmit the image file from the controller to the one or more remote displays.

These methods and systems are advantageous for displaying one or more images on multiple remote displays, wherein the methods and systems do not utilize multiple graphics cards and thus present an economical and simpler configuration over the prior art. Some embodiments disclosed herein can enable efficient, accurate, and economical display of a sheet music image, such as the same image for example, from a central or coordinating computer to remote multiple displays utilized by musicians and/or singers in a music group. Additional advantages will be apparent in view of the detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary multi-display system according to the first embodiment of the present invention;

FIG. 2 is a schematic illustration of an exemplary remote display according to the second embodiment of the present invention;

FIG. 3 is an schematic illustration of an example of a music display and management system with multiple displays controlled by a single computer via a wireless network;

FIG. 4 is a schematic illustration of a music display and management system with multiple displays controlled by a single computer, each display having a wireless receiver to receive the same music image and provide the display to different musicians/singers;

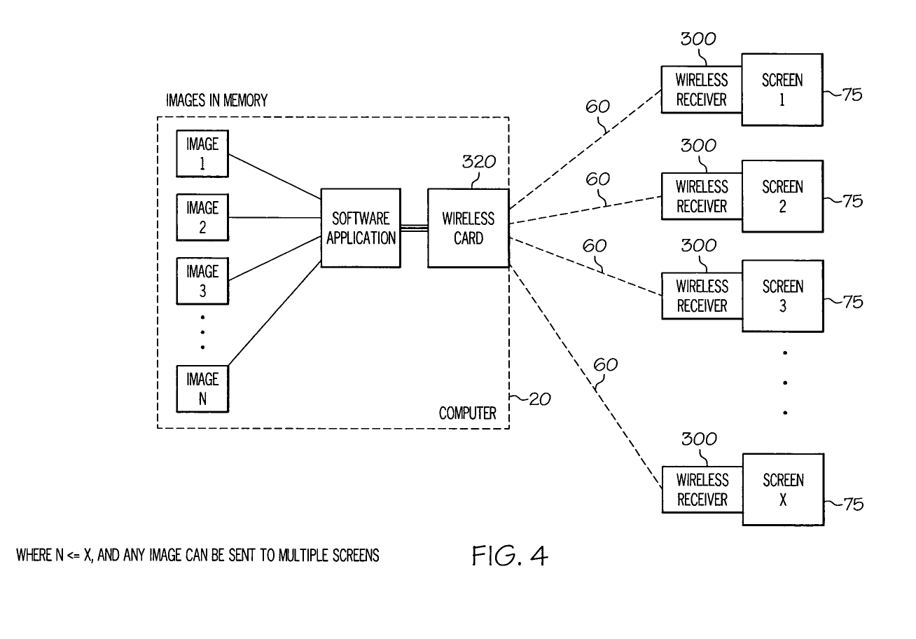

FIG. 5 is a schematic illustration of a music display and management system with multiple displays controlled by a single computer, each display having a network connection to receive the same music image and provide the display to different musicians/singers;

FIG. 6 is a flow chart illustrating an exemplary method for encoding and transmitting a single music file image and providing that image to multiple displays; and

FIG. 7A and 7B are schematic illustrations of exemplary music displays according to various embodiments of the present invention.

The embodiments set forth in the drawings are illustrative in nature and not intended to be limiting of the invention defined by the claims. Moreover, the individual features of the drawing of the invention will be more fully apparent and understood in view of the detailed description.

### DETAILED DESCRIPTION OF THE EXAMPLE EMBODIMENTS

Reference will now be made in detail to various embodiments which are illustrated in the accompanying drawings, wherein like numerals indicate similar elements throughout the views.

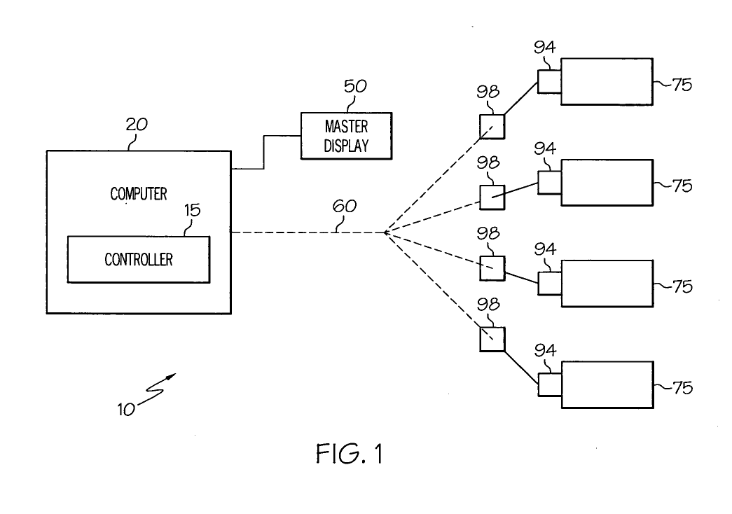

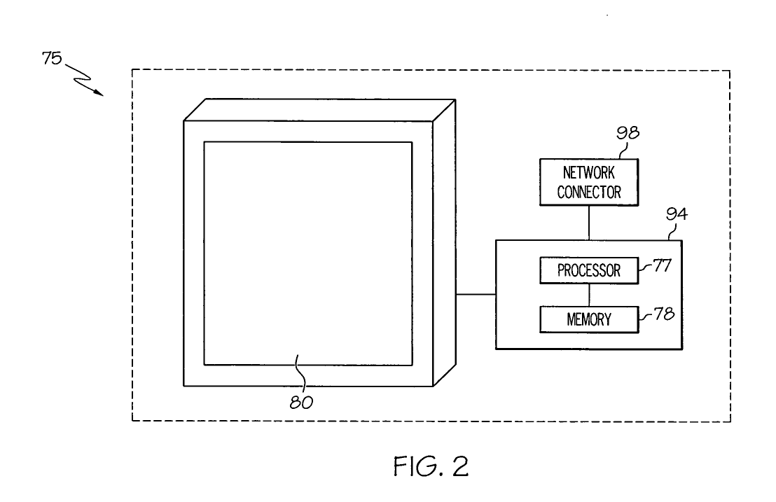

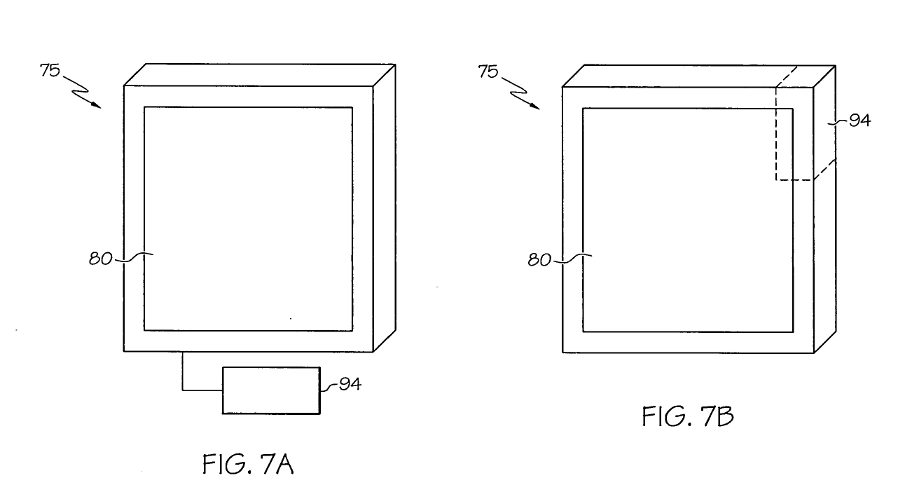

One embodiment of the multi-display system of the present invention is illustrated in FIG. 1. The multi-display system 10 comprises a computer 20, a master display 50 and one or more remote displays 75 in communication with the computer 20 through a communication link 60. In one exemplary embodiment, the communication link 60 is a wired connection, such as Ethernet, Firewire, fiberoptic, USB cable, and the like. In an alternative embodiment, the communication link 60 is a wireless technology such as Wi-Fi, cellular, Bluetooth, RF, IR, and the like. The computer 20 comprises a controller in communication with the one or more remote displays 75 and the primary display 50. In one exemplary embodiment, the controller 15 executes a screen shot generator, wherein the screen shot generator is adapted to create an image file, and wherein the image file comprises an image corresponding to a desired screen display. The image file can be in any of the following formats or other suitable data format: jpg, bmp, gif, tiff, pcx, and the like. This image file is then transmitted from the computer 20 to the remote display 75. The image file is converted to the appropriate communication standard by a video adapter, as shown at block 94 in FIG. 1. In one exemplary embodiment, as illustrated in FIG. 7A, the video adapter 94 is external from the remote display 75. In an alternative embodiment, the video adapter 94 is integral to the remote display 75. The remote displays 75 are configured to be able to receive the image file from the computer 20 and to the display this corresponding image for the image file. In particular, the displays 75 may include a network connector, shown at block 98 in FIG. 2, which is configured to receive the signal from the computer 20 and to convert the signal into an appropriate format for use by the display 75, such as one of the following formats or other suitable format: vga, dvi, xvga and the like. In this embodiment, the computer 20 is not required to have additional video display cards for remote displays 75.

In one exemplary embodiment, as depicted in FIG. 2, the one or more remote displays 75 comprise a processor 77 in communication with the display 80 and the network connector 98. In an alternative embodiment the video adapter 94 may further comprise the processor 77. The processor 77 is configured to execute software on an operating system 10 to convert video data of the image files into a VGA signal. In an alternative embodiment, a separate video adapter or controller is utilized to convert video data of the image files into a VGA signal for the remote displays. In another embodiment, the remote image display 75 further comprises a computer-readable memory storage unit 78 in communication with the processor 77. The memory storage unit 78 provides storage for the software to convert the video data into VGA signals, and in one alternative embodiment, the memory storage unit may store image files transmitted from the controller 15 of the computer 20. In one exemplary embodiment, the remote image file is retrieved from the memory storage device instead of being retransmitted from the controller of the computer. For example, in a thin client embodiment, there may be no need to retransmitted a previously transmitted file if it is already stored on the memory storage device of the thin client. In another exemplary embodiment, the controller 15 of computer 20 “pushes” the remote image file to the one or more remote displays. In an alternate exemplary embodiment, the processor 77 of the remote display 75 “pulls” the remote image file to the remote display 75 from the computer 20. In an alternate embodiment, the software comprises a web browser wherein the web browser is configured to request a file from a predetermined web-server. The web-server can be populated with image files to be displayed on the remote displays 75.

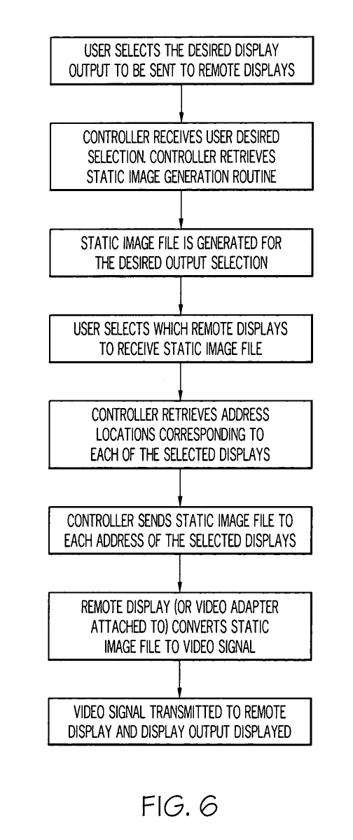

Another embodiment of the present invention, illustrated in FIG. 6, is a method for displaying one or more static images on multiple remote displays. This method comprises providing one or more remote displays 75, wherein the remote display 75 comprise the ability to display image files without the need of additional video cards on the server computer. In this embodiment, each of the remote displays 75 has an address. One or more static image files are generated by the controller 15 of the main computer 20. The static image files generated correspond to the desired display output presented to a user on one or more of the remote displays 75. A static image file is typically a file containing a discrete set of data which can be in a variety of formats such as jpg, gif, pcx, pdf, and the like as opposed to a convention video file which contains streaming video data. The controller 15 then determines which of the remote displays 75 to transmit the one or more static image files to. After determining which display to transmit the remote image file to, the controller determines the address of the desired remote displays 75 for the image file to be transmitted. The controller 15 then transmits one or more static image files to the corresponding addresses for the one or more remote displays 75, depending on which displays/persons require the given image. For example, in a music display system for a band, choir, or other music group, certain singers or musicians may need a particular music sheet, while others may need another version of that music sheet. In a further embodiment, the one or more remote displays 75 receive the image file and a processor 77 (attached to or part of the display) executes the image file to create a visual display on the display 75. In one exemplary embodiment, the image file is immediately executed and displayed on the display 75, whereas in an alternative embodiment, the image file is stored in the memory 78 of the remote display 75 until a predetermined time or signal is generated and transmitted from the computer 20 to the remote display to execute on the processor 77 the commands to display the image on the remote display 75.

Yet another embodiment of the present invention is a method for displaying one or more images on multiple remote displays. The method comprises selecting an image to be displayed on one or more remote displays; generating a remote image file corresponding to the selected image; and transmitting the remote image file to the one or more remote displays, wherein the one or more remote displays are configured such as to display an image corresponding to the remote image file.

In one exemplary embodiment, the remote image file is transmitted to the one or more remote displays in response to request for the remote image file from the one or more remote displays. In yet another exemplary embodiment of the present invention, the method further comprises generating a synchronization timing file, wherein the synchronization timing file comprises a set of instructions for displaying one or more remote image files in a predetermined order. In one exemplary embodiment, the synchronization file is transmitted to the remote image display, and wherein the synchronization timing file requests one or more remote image files to be displayed on the one or more remote displays. In another exemplary embodiment, the synchronization timing file comprises a list of web pages or files to be loaded into the web browser or display software at predetermined times. In an alternative embodiment, the synchronization file is executed by the main controller 15, wherein the main controller 15 transmits the remote image files at a predetermined time to the one or more remote displays. In one exemplary embodiment, multiple remote image files are transmitted to a storage device located at or near the one or more remote displays. Such storage device may comprise a computer readable memory such as flash memory or hard drive storage devices.

In another exemplary embodiment of the present invention, the remote image file is regenerated and retransmitted to the one or more remote displays at a predetermined refresh rate. Exemplary refresh rates range from several times per second to once per minute. One exemplary refresh rate is from about 1 to about 2 seconds per screen refresh. In one exemplary webpage embodiment, the refresh rate can be programmed into the webpage.

In another exemplary embodiment of the present invention, the multi-display system comprises a control station and multiple thin client units in communication with the control station. Each of the thin client units can be connected to one or more remote displays and/or input devices. The control station may comprise a personal computer or other networked device in communication with multiple thin client units. A thin client is a network computer typically without a hard disk drive, which, in client/server applications, is designed to be especially small so that the bulk of the data processing occurs on the server. However, in an alternative embodiment, the thin client handles the bulk of the data processing. In one embodiment, the thin client executes a software program/operating system which communicates with the control station.

In one exemplary embodiment, the multi-display system comprises a system of networked computing systems, for example a primary personal computer (control station) and one or more multiple thin clients (secondary units), wherein the primary personal computer coordinates music for all of the thin clients, and wherein the thin clients are connected to one or more remote displays.

In one embodiment, the primary unit (control station) networks and links to a group of secondary units. In this embodiment, the primary unit has functionality which includes at least one of the following: the ability to download a list of songs including the song content to one or more secondary units; the ability to select the type/part of music (e/g. trumpet part, piano part, etc.) and send the music content for the selected type for the list of songs to one or more secondary units; the ability to synchronize the list of songs to be displayed on the secondary units; the ability to select the play order of the songs of the playlist in the secondary units; the ability to send commands to select the ‘now playing’ song for the secondary units; the ability to send user defined messages to individual secondary units, groups of secondary units or all of the secondary units; the ability to edit one or more pages of a particular song and send edited page to one or more designated secondary units, such edits include annotations and revised pages, etc.; the ability to receive annotations and other edits from a secondary unit and there store edited/annotated page in database; the ability to synchronize and display a timing devise (e.g. metronome) or sound an audio output on each or selected ones of the secondary units, as well as the ability to maintain such synchronization.

In another embodiment, the secondary units have one or more of the following functionality: the ability to operate in a networked environment or in a “stand-alone” mode; the ability to allow a user to annotate/edit/mark-up pages of music using a user input interface such as a keyboard and mouse device; the ability to allow the user to change the song or displayed page using an input device; the ability to change the song or displayed page on other secondary units displaying the same content as primary unit; and the ability to send user defined messages to the control station and/or other secondary units.

In another exemplary embodiment, each of the remote displays is assigned an address. In a further exemplary embodiment, the address comprises an IP address, wherein each of the one or more remote displays has a unique IP address. In another exemplary embodiment of the present invention, the method further comprises storing the addresses in an address storage table. The address storage table can then be utilized by the controller to transmit image files to a specific address corresponding to one or more remote displays. In another exemplary embodiment, the remote displays can be addressed by a subset name such as section names or instrument part names. For example, one or more remote displays could be labeled “Sopranos”, “Altos”, “Tenors” and “Basses”. Alternatively, the displays could be labeled “guitar 1”, “guitar 2”, “flutes”, “trumpets”, “bass”, etc. The label for these displays would then be associated with addresses for those displays, with particular outputs from the computer, or with particular signal types or identifiers. An image that is to be transmitted to the “Basses” for example, can then be transmitted by selecting the group name “Basses”, which then causes the single image file to be converted to the appropriate format and output using the appropriate addresses, outputs, or signals to the appropriate displays. Rather than sending individual streaming video signals to each of the displays and the required video display adapters required to generate such video signal, this embodiment sends a single static image file to the desired group of displays.

In one embodiment of the present invention, the method further comprises generating a graphic user interface, whereas the graphic user interface is configured to allow a user, such as the director or conductor, to select one or more remote displays to receive the remote image file. In one exemplary embodiment, the graphical user interface comprises a representation of each remote image file being displayed on a corresponding remote display.

In another exemplary embodiment of the present invention, the remote image file comprises a screen shot or static image of the image to be displayed. In another alternative embodiment, the remote image file comprises video memory corresponding to the image to be displayed. In another exemplary embodiment, the remote image file comprises an HTML or XML file comprising one or more screen displays.

In one exemplary embodiment of the present invention, the multi-display system 10 is embodied in a music display system. The music display system is configured to display music for a team of musicians or singers, such as in a church music team environment. In one exemplary embodiment, such as a church music team environment, a church may have hundreds of songs to select from for a particular service. In a service a subset of songs may be selected to be played. In addition, it may be desirable to occasionally change one or more of the songs, or to change the order of the songs to be played. In a traditional music performance setting using paper sheets of music, it may be impossible to play a song that was not originally selected as the order of songs for the service due to the fact that music may not be distributed to each of the team members. In addition, changing the order of the music can also be difficult as the musician is typically using their hands for their instrument which limits their ability to swap the order of the music on their stand. Other times, it may be desirous to change the keys to the song. Many church worship leaders either limit their song selection to the same key or transpose the key to the song by hand and make copies for the team. In the present invention, the change in the music can be quickly sent to the one or more remote displays.

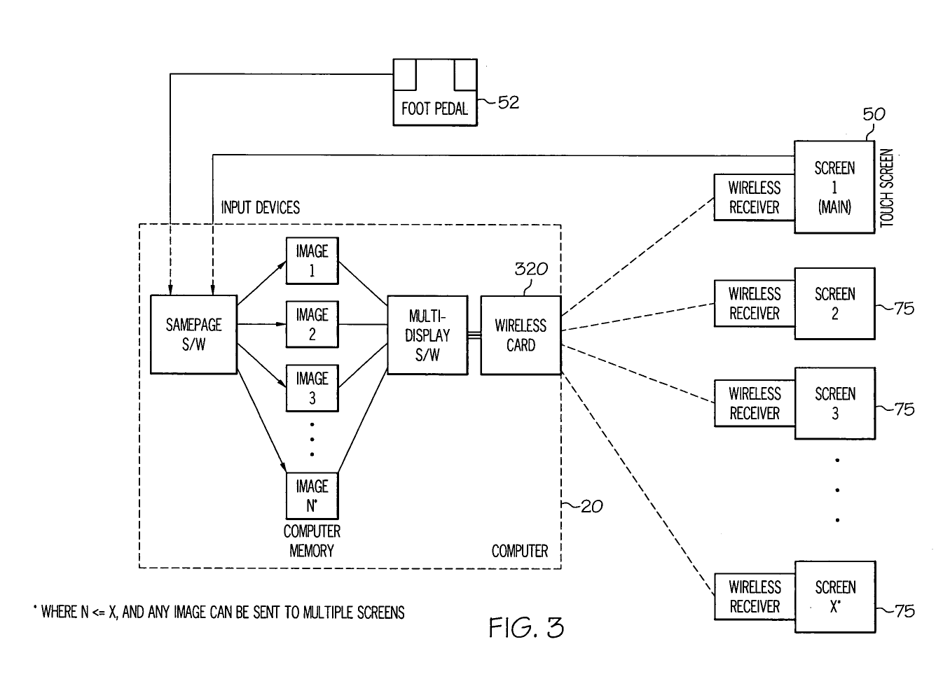

The music display system of this embodiment, illustrated in FIG. 3, comprises a master display 50, one or more input devices 52, and one or more remote displays 75. In one exemplary embodiment, the master display 50 comprises a touch screen display. The touch screen display may comprise a computer itself or be in communication with a computer 20. The touch screen is intended to be used by the music team leader for song selection, song order, song key, display format, and other features. The one or more input devices 52, such as a foot pedal or a hand wireless remote, are used to input user input into the system. Each of the remote displays are connected to the main computer via a wireless or wired connection. In the particular embodiment illustrated in FIG. 3, each of the remote displays are connected to a network, wherein the computer 20 is connected to the same network. In one exemplary embodiment, each of the one or more remote displays are in communication with a video display adapter device such as a processor and graphics adapter and the like. Such video display adapters may comprise personal computers, laptops and the like. In an alternative embodiment, the remote display is configured to connect to a network and has the ability to generate video display signals.

In one exemplary embodiment, each of the remote displays 75 comprises a communications processing device. In this embodiment, the controller connects to the multiple remote displays and is able to send various display modes (images of sheet music) of the same song to various monitors. The communications processing device comprises a communication link and adapter card. For example, the communications processing device comprises an Ethernet card or a wireless network adapter card.

One embodiment of the present invention is a method of transmitting images saved in memory to various remote monitors or displays. These images can comprise image files. Alternatively, the image files could be actual video memory for the video display adapter of the remote display. In one exemplary embodiment, the images can be saved in memory as files. In one exemplary embodiment, the graphical user interfaces include logic to allow the user to select which static image files are sent to which remote monitors or displays. One static image file can be sent to multiple wireless monitors.

In yet another exemplary embodiment, the system further comprises a user interface that allows the various images to be named (for example, keyboard, vocals, guitar, flute, etc.) and allows the various displays to be named (for example, keyboard, vocals, guitar, flute, etc.). In one exemplary embodiment, the graphic user interface is configured to allow for the user to select which images are to be displayed on each of the remote displays.

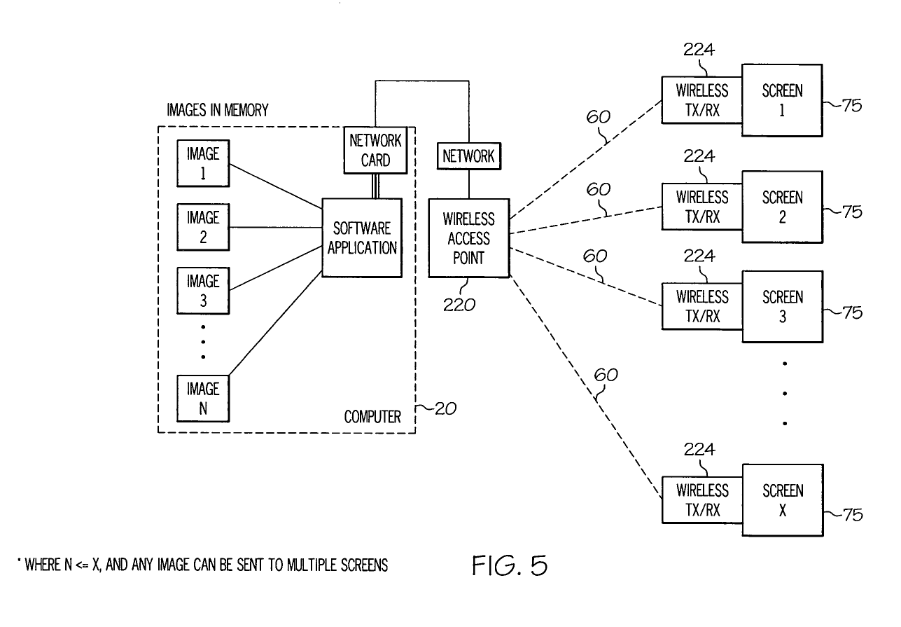

In one exemplary embodiment of the present invention, illustrated in FIG. 5, the communication link 60 comprises one or more various IEEE 802.11 wireless communications protocol. Typically a wireless access point or router 220 will transmit the signals carrying the static image files to a wireless access card 224 connected to the remote display 75 or external video display adapter (not shown). If this communication protocol were utilized, the image file can be converted into a 2.4 GHz or 5 GHz radio frequency signal and encoded onto the signal using complementary code keying (CCK) coding wherein it can transmit 11 megabits of data per second or orthogonal frequency division multiplexing wherein it can transmit up to 54 megabits of data per second. It is possible in another embodiment for the computer to connect to a network via landline or other and network communication devices such as wired or wireless hub, router, or other technology known to one skilled in the art.

In one exemplary embodiment, the one or more remote displays comprise a wireless receiver 300 in communication with a wireless transmitter 320 in communication with the computer 20. In a further embodiment, the one or more remote displays comprise touch screens, configured to allow a remote user to communicate to another user of the music display system by touching the screen and composing a message. In one exemplary embodiment, the message is predefined. In an alternative embodiment, a keypad is displayed upon the display and is configured to allow the user to enter a message. In yet another exemplary embodiment of the present invention, a primary user, such as a director, is able to select the output for the remote displays via a master display and input device.

In one embodiment of the present invention, a screen shot generator program is configured to create multiple static image files of music song sheets in memory. The controller then selects and sends the images to one or more remote displays. In one exemplary embodiment, the one or more remote displays may further comprise an input device. The input device can be utilized by a remote user to send a signal to the controller 20 to retransmit and/or regenerate the remote image file. For example, in the music embodiment, the remote user may desire a different instrumentation or vocal piece of the music, and/or the music in a different key. This music file can be generated by the controller and then retransmitted to the remote display.

The foregoing description of the various embodiments and principles of the invention has been presented for the purposes of illustration and description. It is not intended to be exhaustive or to limit the invention the precise forms disclosed. Many alternatives, modifications, and variations will be apparent to those skilled in the art. For example, some of the principles of this invention may be utilized in different multi-display systems such as educational purposes, advertising, music groups, and the like. Moreover, although model presentive concepts have been presented, such aspects need not be utilized in combination, and various combinations of inventive aspects are possible in light of the various embodiments provided above. Accordingly, the above description is intended to embrace all possible alternatives, modifications, combinations, and variations, and have been discussed or suggested herein, as well as all others that fall within the principles, spirit, and broad scope of the invention as defined by the claims.

What is claimed is:

1. A method for displaying one or more images on one or more remote displays, comprising:
providing one or more remote displays, wherein each of the one or more remote displays comprises the ability to display an image file, and wherein each of the remote displays has an address;
generating one or more image files to be displayed on one or more remote displays, wherein each of the one or more image files corresponds to a desired display output presented to a user;
determining the address of which of the one or more remote displays to transmit the one or more image files;
transmitting the one or more image files to the corresponding addresses for each of the one or more remote displays

2. A method for displaying one or more images on multiple remote displays, comprising:
selecting an image to be displayed on one or more remote displays;
generating a remote image file corresponding to the selected image;
transmit the remote image file to the one or more remote displays, wherein the one or more remote displays are configured such as to display an image corresponding to the remote image file.

3. The method of claim 2, wherein the remote image file is transmitted to the image file in response to a request for the remote image file from the one or more remote displays.

4. The method of claim 2, further comprising generating a synchronization timing file, wherein the synchronization timing file comprises a set of instructions for displaying the one or more remote image files in a predetermined order.

5. The method of claim 2, wherein the remote image file, after being transmitted, is stored in a memory storage device of the one or more remote displays.

6. The method of claim 4, wherein the synchronization file is transmitted to the remote image display.

7. The method of claim 6, wherein the synchronization file comprises executable instructions which request one or more remote image files to be displayed on the one or more remote displays.

8. The method of claim 2, wherein the synchronization file is executed by a main controller, and wherein the main controller generates the remote image files.

9. The method of claim 2, wherein multiple remote image files are transmitted to a storage device located at or near the one or more remote displays.

10. The method of claim 2, wherein the remote image file is regenerated and re-transmitted to the one or more remote displays at a predetermined refresh rate.

11. The method of claim 10 wherein the refresh rate is from about 1 to about 2 seconds.

12. The method of claim 2, wherein each of the one or more remote displays is assigned an address.

13. The method of claim 12, wherein the address comprises an IP address and wherein each of the one or more remote displays has a unique IP address.

14. The method of claim 12, further comprising storing the addresses in an address storage table.

15. The method of claim 13, wherein the remote image file is transmitted to specific addresses corresponding to one or more remote displays.

16. The method of claim 15, further comprising: selecting the one or more addresses utilizing a graphic user interface to select the one or more remote displays to receive the remote image file.

17. The method of claim 16, further comprising: displaying on the graphical user interface a representation of each remote image files being displayed on a corresponding remote display.

18. The method of claim 2, wherein the remote image file comprises a screenshot of the image to be displayed.

19. The method of claim 2, wherein the remote image file comprises video memory corresponding to the image to be displayed.

20. The method of claim 2, wherein each of the one or more remote displays comprises an network communication link, a processor, and computer readable memory, wherein the processor is adapted to display images on the remote display.

21. A music display system, comprising
a computer in communication with a graphical user interface, wherein the graphical user interface is adapted to allow a user to select one or more images of sheet music to be displayed on one or more remote displays;
a controller with received a user's selection of one or more image to be displayed on one or more remote displays, wherein the controller is adapted to generate a static image file corresponding to the one or more selected images of sheet music;
a transmitter in communication with the controller, wherein the transmitter is configured to send the generated static image files to one or more remote displays; and
wherein the one or more remote displays are configured to receive one or more static image files from the controller, wherein the remote displays are configured to display an image corresponding to the received static image files.

22. The music display system of claim 21, wherein the one or more remotes displays further comprise a converter configured to convert the static image files into a video signal for the remote displays.

23. The method of claim 5, wherein the remote image file is retrieved from the memory storage device instead of being retransmitted.
